(19) United States
(12) Patent Application Publication
(10) Pub. No.: US 2001/0028621 A1
(43) Pub. Date: Oct. 11, 2001

(54) Optical pickup apparatus

(76) Inventor: Katsuya Moriyama, Nagano (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/778,054

(22) Filed: Feb. 7, 2001

(30) Foreign Application Priority Data
Feb. 8, 2000 (JP) P. 2000-30452
May 16, 2000 (JP) P. 2000-142612

(51) Int. Cl. G11B 7/135

(52) U.S. Cl. 369/112.23; 369/120

(57) ABSTRACT

In an optical pickup apparatus, a light source, a photo device and optical elements, constructing an optical system for converging a light emitted by the light source on an optical recording medium and guiding a returning light reflected by the optical recording medium to the photo device, are mounted on a frame which is composed of a wiring board having wiring patterns, including circuits of electric supply to the light source and the photo device.

### BACKGROUND OF THE INVENTION

The present invention relates to an optical pickup apparatus for recording/reproducing data in optical recording disks such as CDs (compact disks), DVDs (digital video disks), etc. More specifically, it relates to a mounting structure of a light source, a lens holder, a photo device, and various optical elements onto a fame in an optical pickup apparatus.

The present invention relates to an optical pickup apparatus used for data recording/reproduction with respect to optical recording media. More specifically, it relates to an optical pickup apparatus having a configuration that can make the device thin with low cost.

An optical pickup apparatus used for recording/reproducing data in optical recording disks, such as CDs, DVDs, etc., is constructed as shown in FIG. 19. In an optical pickup apparatus 1A shown here, a light source unit 4A, in which a semiconductor laser (light source or a light emitting element), a photo device, diffraction gratings (a hologram device), etc. are made as a unit, a reflecting mirror 5 for guiding a light emitted by the light source unit 4A to an objective lens 60, and a yoke board 62 which has yoke portions 63 standing upright are directly mounted on a metallic frame 2.

A shaft 65 stands upright on the yoke board 62, and a shaft hole 69 is bored in a lens holder 61 that holds the objective lens 60. Then, the shaft 65 is pushed in the shaft hole 69 to mount the lens holder 61 onto the yoke board 62. Thus, an actuator 6 for magnetically driving the objective lens 60 in the focusing and tracking directions can be integrated on the yoke board 62.

Also, in the optical pickup apparatus 1A, a (drive) coil for focusing and a drive coil for tracking are formed on the lens holder that holds the objective lens 60; therefore, a flexible print board 82 is connected to the lens holder 61. Also, a flexible print board 83 is connected to the light source unit 4A. The flexible print boards 82 and 83 are both connected to external circuits (not illustrated). Note that a metallic piece such as a flat spring (not illustrated) is sandwiched between the light source 4A and the frame 2 for heat release. The heat generated by the light source unit 4A is released to the frame 2 through the metallic piece.

In the optical pickup apparatus 1A configured as above, each light source unit 4A, reflecting mirror 5, and actuator 6 is individually configured. However, when mounted on the frame 2, the light source unit 4A, the reflecting mirror 5, and the objective lens 60 need to be on the same optical axis. Therefore, the mounting positions of these elements need to be adjusted one by one on the frame. Elaborate work is required in the assembly of the related optical pickup apparatus 1A. Also, since two flexible print boards 82 and 83 are used, much time and effort needs to be put into the wiring process. In addition, using two boards of expensive flexible print boards 82 and 83 increases the cost of element.

Further, the metallic piece such as a flat spring needs to be inserted between the light source unit 4 and the frame 2 to release the heat generated by the light source unit 4 toward the frame 2. Because of the structure for heat release, the overall configuration of the apparatus is complicated, increasing the number of elements to be used and making it difficult to make the device thin.

In recent years, a light source unit 4A, in which the light emitting element, the photo device, and the hologram device are made in a single package, is mostly used to make a compact, thin optical pickup apparatus 1A. By using the light source unit 4A, the number of elements to be used can be reduced, and the optical positional adjustment between the light emitting element and the photo device can be simplified.

However, although the light source unit is advantageous to make the device thin or to simplify the positional adjustment, it is normally expensive, so increasing the cost of optical pickup apparatus.

Further, since the optical elements mounted on the device frame need to be positioned with high precision, a special device and extra effort are required for positional adjustments of the elements, thus increasing the cost. In addition, the demand is high on process precision (die precision) of the mounting surface of the device frame for the optical elements; therefore, it ends with costly die manufacturing and precision control thereof.

### SUMMARY OF THE INVENTION

Considering the above mentioned problems, an objective of the present invention is to provide an optical pickup, in which the positional arrangements of various elements can be easily adjusted, and the number of flexible print boards to be used is reduced. This improves the productivity and reduces the cost of elements.

Another objective of the present invention is to provide an optical pickup apparatus that can improve the efficiency of releasing heat generated by the light source without increasing time and effort required for assembly.

Considering the above problems, an objective of the present invention is to provide an optical pickup apparatus that can be made thin.

Another objective of the present invention is to provide an optical pickup apparatus that can configure a structure of heat release from the light emitting element while still maintaining a thin, simplified configuration.

Further, another objective of the present invention is to provide an optical pickup apparatus in which the optical elements can easily be positioned.

In order to achieve the above objects, according to the present invention, the elements are mounted on the rigid wiring board. Therefore, the wiring patterns engraved into the wiring board can be used for wiring the light source. Consequently, the number of expensive flexible print boards to be used can be reduced, there is not much time and effort required for wiring the flexible print board, and the cost of elements can be reduced. Also, since the light source, lens holder, photo device, and optical elements are mounted directly on the rigid wiring board or on the rigid board mounted on the wiring board, the optical axis can be easily adjusted. Compared to the related art in which each element is mounted directly on the frame, the optical adjustment can be performed with less time and effort. Therefore, the productivity of the optical pickup apparatus can be improved.

According to the present invention, the elements are mounted on the frame composed of a wiring board. Therefore, using the wiring patterns engraved into the wiring board, the compound chip of the semiconductor and photo device comprising the semiconductor substrate in which the photo device is built in, the sub mount, and the semiconductor laser chip can be directly mounted on the surface of the wiring board. Therefore, the device can be made thin without using an expensive light source unit, in which the light source and the photo device are made in a unit.

In addition, there is no need to prepare the device frame and the wiring board separately, and only a small space is required for electrically connecting the wiring board; therefore, even when the present invention is applied to an optical pickup apparatus of a bulk type, the device can be made small, especially thin.

Further, a metallic wiring board having a given rigidity can be adopted for the wiring board. With this, the semiconductor laser, a source of heat generation, is directly mounted on the wiring board frame; therefore, there is no need to separately provide a heat releasing board, etc., but the heat can still be efficiently released. Thus, even from this viewpoint, the device can be made small and thin.

Still further, in the present invention, the element holder which can determine the position of each optical element is mounted on the wiring board, and each optical element is mounted in this element holder; therefore, the mounting of the optical elements and the adjustments of the optical positions thereof can be easily performed.

In addition, since the device frame is composed of a wiring board, the wiring patterns thereon can be used to reduce the number of the expensive flexible print boards to be used. It also reduces the time and effort required for electrically connecting the flexible print board, thus reducing the cost of device and simplifying wiring.

### BRIEF DESCRIPTION OF THE DRAWINGS

In the accompanying drawings:

FIG. 1 is a block diagram of an optical pickup apparatus according to a first embodiment of the present invention;

FIG. 2 is a perspective view of the dissembled optical pickup apparatus of FIG. 1;

FIG. 3 is a process diagram of assembly steps of the optical pickup apparatus of FIG. 1;

FIG. 4 is a perspective view of a dissembled optical pickup apparatus according to a second embodiment of the present invention;.

FIG. 5 is a perspective view of a dissembled optical pickup apparatus according to a third embodiment of the present invention;

FIGS. 6A and 6B respectively show a plan view and a cross-sectional view of an optical pickup apparatus according to a fourth embodiment of the present invention;

FIG. 7 is a plan view of a wiring board frame of FIG. 6;

FIGS. 8A and 8B respectively show a plan view of a compound chip of FIG. 6 and a perspective view of optical elements mounted in an element holder;

FIG. 9 is a process diagram of assembling steps of the optical pickup apparatus of FIG. 6;

FIGS. 10A and 10B respectively show a plan view and a cross-sectional view of an example of modification of the wiring board frame, primary shaft guide, and secondary shaft guide in the optical pickup apparatus of FIG. 6;

FIGS. 11A and 11B respectively show a plan view and a cross-sectional view of another example of modification of the wiring board frame, primary shaft guide, and secondary shaft guide in the optical pickup apparatus of FIG. 6;

FIG. 12A is a perspective dissembled view of an example of modification of the element holder and wiring board frame in the optical pickup apparatus of FIG. 6;

FIGS. 12B through 12G illustrate examples of mounting portions for a mirror of FIG. 12A;

FIGS. 13A, 13B and 13C respectively show a perspective dissembled view of an example of modification of the element holder of FIG. 12, a mounting portion for a shaft, and another example of the mounting portion for the shaft;

FIGS. 14A and 14B respectively show a perspective dissembled view of another example of modification of the element holder of FIG. 12, and a mounting portion for a wire suspension retaining board;

FIG. 15 is a plan view of an example of a mounting structure of the compound chip in the optical pickup apparatus of FIG. 6;

FIGS. 16A, 16B, and 16C respectively show a perspective dissembled view of an optical pickup apparatus according to a fifth embodiment of the present invention, a mounting diagram of the optical elements thereof, and a detailed diagram of a semiconductor laser mounting portion;

FIGS. 17A, 17B, and 17C respectively show a perspective dissembled view of an example of modification of the element holder of FIG. 16, a mounting diagram of the optical elements thereof, and a detailed diagram of a semiconductor laser mounting portion;

FIGS. 18A, 18B, and 18C respectively show a perspective dissembled view of another example of modification of the element holder of FIG. 16, a mounting diagram of the optical elements thereof, and a detailed diagram of a semiconductor laser mounting portion; and

FIG. 19 is a perspective view of a dissembled related optical pickup apparatus.

### DETAILED DESCRIPTION OF THE PREFERRED EMBODIMENTS

An optical pickup apparatus of the present invention is described hereinafter referring to the drawings. Note that, since a basic configuration is common to the related one, the common elements are given the same codes.

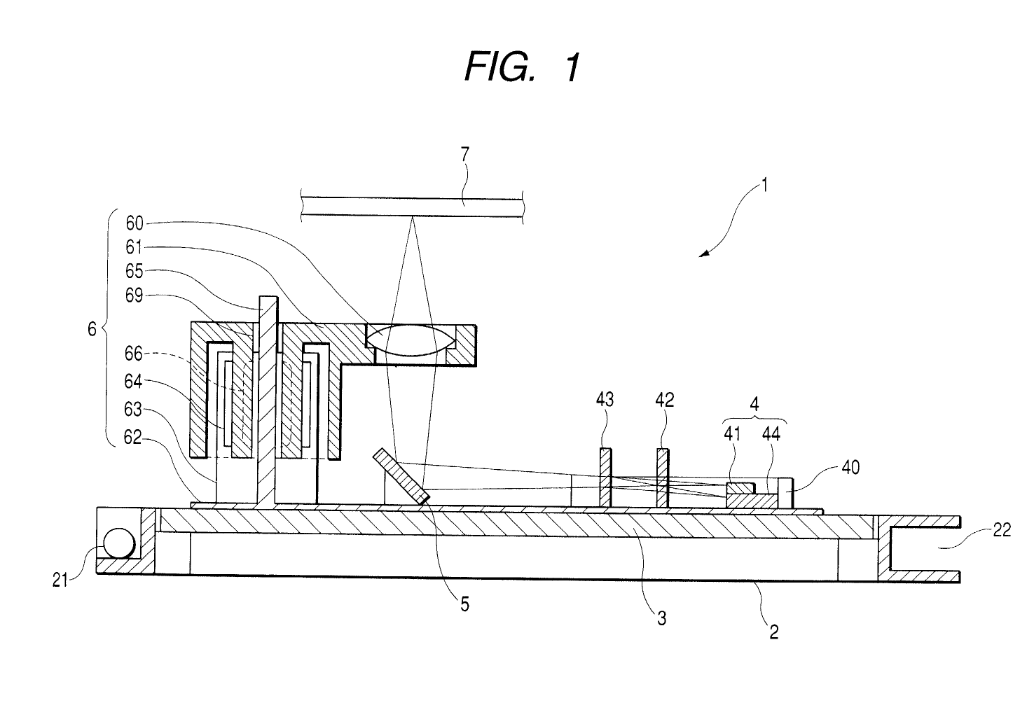

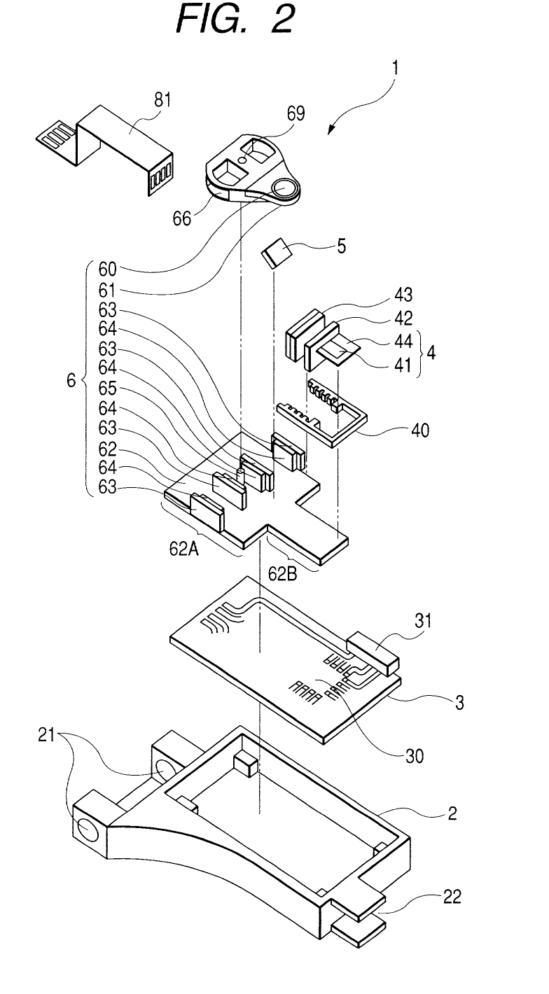

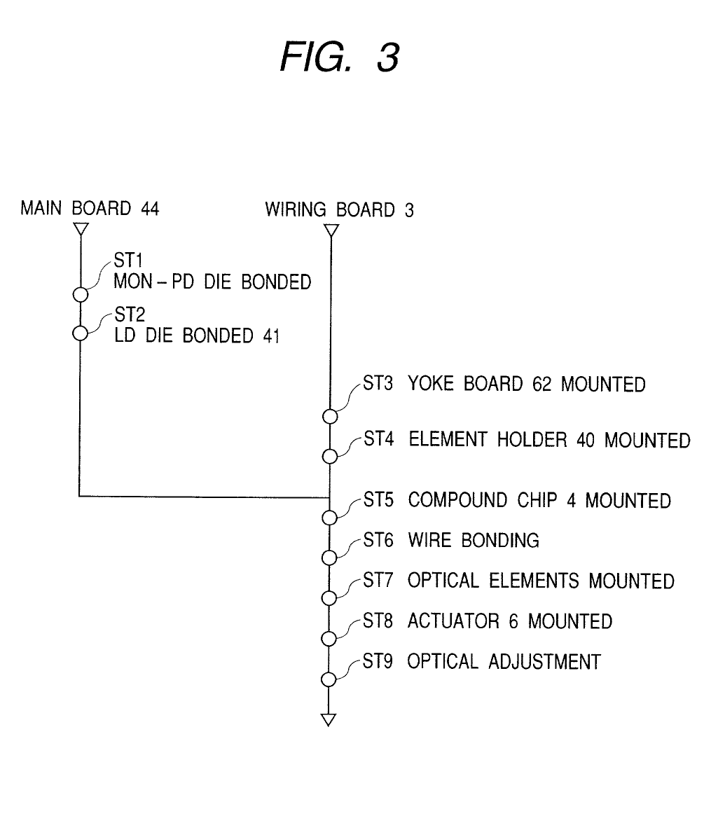

FIG. 1 is a block diagram of an optical pickup apparatus according to a first embodiment of the present invention. FIG. 2 is a perspective view of the dissembled optical pickup apparatus; FIG. 3 shows steps of assembly of the optical pickup apparatus.

As shown in FIG. 1, an optical pickup apparatus 1 of this embodiment records/reproduces data in an optical recording disk 7 (optical recording medium) such as a CD or DVD, and various elements are mounted on a frame 2 made of a metal such as aluminum. Formed at both ends of the frame 2 are a circular guiding hole 21 and a guiding portion 22 projecting in a substantially U-shape. Guiding shafts (not illustrated) are inserted through the guiding hole 21 and guiding portion 22 to enable the optical pickup apparatus to move in the radial direction, the direction of radius of the optical recording disk.

Used in the optical pickup apparatus 1 is a compound chip 4 of an integrated semiconductor laser and photo device. The compound chip 4 is made such that a sub mount board (not illustrated in FIG. 1), on which a photo device for monitoring is formed, and a semiconductor laser (light source) 41 are layered on a main board 44. In the compound chip 4, the main board 44 has a photo device for signal reproduction and an arithmetic circuit that calculates the detection results by the photo device.

On an optical path from the compound chip 4 to the optical recording disk 7, an objective lens 60 is positioned for converging a laser light emitted by the compound chip 4 on a recording surface of the optical recording disk 7 as an optical spot. Positioned between the objective lens 60 and the compound chip 4 are a first diffraction grating 42, a second diffraction grating 43, and a reflecting mirror 5. They are optical elements for guiding the returning light, which has reflected on the optical recording disk and passed through the objective lens 60, to the photo device in the compound chip 4. Note that the first diffraction grating 42 splits the light emitted by the semiconductor laser into three beams; the second diffraction grating 43 changes the optical path of the returning light to guide it to the photo device.

Also, mounted on the frame 2 is a magnetically driven actuator 6 via a wiring board 3 and a yoke board 62 that will be described later. The actuator 6 drives the lens holder 61 holding the objective lens 60 in the focusing and tracking directions. In this embodiment, the actuator 6 slides on and rotates around the shaft; on the yoke board 62, four yoke portions 63 stand up and a shaft 65 stands upright. On the other hand, in the lens holder 61 holding the objective lens 60, a shaft hole 69 is bored so that the shaft 65 can be inserted in. Here, while drive coils 66 and cores (not illustrated) for focusing and tracking are formed in the lens holder 61, drive magnets 64 for focusing and tracking are adhered on the yoke portions 63. Therefore, as the shaft 65 is pushed into the shaft hole 69 of the lens holder 61, the lens holder 61 is supported on the shaft 65 such that the drive coils for focusing and tracking 66 face the drive magnet for focusing and tracking 64.

In the above manner, the actuator 6 is configured on the yoke board 62. The actuator 6 drives the objective lens 60 in the tracking error correcting direction and focusing error correcting direction, based on the tracking error signal and focusing error signal contained in the returning light. In other words, when, in the actuator 6, each of the drive coils 66 is electrified, the objective lens 60 (the lens holder 61) can be moved up and down (in the focusing direction) along the shaft 65, and can also be rotated around the shaft 65 (in the tracking direction).

In the optical pickup apparatus 1 configured above, the compound chip 4 of integrated semiconductor laser and photo device, the lens holder 61, and the optical elements (first diffraction grating 42, second diffraction grating 43, reflecting mirror 5) are mounted onto the frame 2 via the yoke board 62 and the wiring board 3, with the configuration as shown in FIG. 2.

Referring to FIG. 2, in the optical pickup apparatus 1 of this embodiment, the rigid wiring board 3 such as a glass epoxy board or metallic board is mounted inside the frame 2. Engraved into the wiring board 3 are the pattern for electric supply to the semiconductor laser of the compound chip 4, the wiring pattern for signal output by the photo device, and the wiring pattern for electric supply to the drive coils; a connector 31 is mounted on the wiring board 3 for connecting the wiring patterns to the external source. Electronic elements such as resistance and condenser (not illustrated) are also mounted to the wiring board 3.

In the wiring board 3, both the terminal formed at the end of the pattern of the electric supply to the semiconductor laser of the compound chip 4 and the terminal formed at the end of the wiring pattern for signal output by the photo device are arranged in a predetermined area on the wiring board 3. The area in which these terminals are arranged is a chip mounting area 30 (light source mounting area).

The yoke board 62 consists of a rectangular area 62A, in which the yoke portions are formed, and a rectangular heat releasing board 62B projecting from the rectangular area 62A to be of a T-shape. The yoke board 62 is layered on the top surface of the wiring board 3 such that the heat releasing board 62B is positioned inside the chip mounting area 30. The lens holder 61 is mounted in the rectangular area 62A, in which the yoke portions are formed, and the reflecting mirror 5 is mounted in the joining area of the rectangular area 62A and heat releasing board 62B.

Between the lens holder 61, which is mounted on the wiring board 3 via the yoke board 62, and the wiring board 3, a flexible print board 81 is bridged so that the electricity can be supplied from the external source to the drive coils 66 via the connector 31 and wiring pattern on the wiring board 3.

In this embodiment, the compound chip 4, the first diffraction grating 42, and the second diffraction grating 43 are mounted on the heat releasing board 62B of the yoke board 62 with a element holder 40 used for their positioning. In other words, the element holder 40 is a substantially U-shaped (plan view) enclosure member of a photosensitive glass and has recesses, protrusions, and windows inside thereof for holding the compound chip 4, the first diffraction grating 42, and the second diffraction grating 43 in predetermined positional arrangements. The compound chip 4, first diffraction grating 42, and second diffraction grating 4 are simply mounted in the element holder 40, and the bottom surfaces thereof contact the top surface of the yoke board 62. Consequently, the optical axis therebetween can be automatically adjusted.

Here, the element holder 40 is layered on the yoke board 62, and the heat releasing board 62B of the yoke board 62 is layered on the inner area of the chip mounting area 30. Therefore, with the element holder 40 mounted on wiring board 3, the compound chip 4 is layered on the heat releasing board 62B of the yoke board 62. The compound chip 4 mounted on the yoke board 62 as above is wire-bonded with the wiring board 3.

The steps of mounting each element in such a structure will be described referring to FIGS. 2 and 3.

Referring to FIG. 2 and FIG. 3, in Steps ST1 and 2, a sub mount board having a monitoring photo device (MON-PD) formed thereon and the semiconductor laser 41 are mounted in order on a main board 44, in which the signal reproducing photo device and arithmetic circuit, with an adhesive to create the compound chip 4 of the integrated semiconductor laser and photo device.

Resistance, condenser, and connector 31 are mounted on the wiring board 3 in advance. In Step ST3, the yoke board 62 is layered on the wiring board 3. In Step ST4, the element holder 40 is mounted on the yoke board 62. Then, in Step ST5, the compound chip 4 is mounted on the element holder 40; in Step ST6, the main board 44 and sub mount board are wire-bonded and the semiconductor laser 41 and wiring board 3 are also wire-bonded. In Step ST7, the first and second diffraction gratings 42 and 43 are mounted in the element holder 40. Also, the reflecting mirror 5 is mounted on the yoke board 62.

Next, in Step ST8, the drive magnets 64 are adhered on the yoke portions 63 on the yoke board 62 that has already been mounted on the wiring board 3, and the lens holder 61 is attached to the shaft 65 to mount the actuator 6. Also, the wiring board 3 and the lens holder 61 are electrically connected through the flexible print board 81.

After the flexible print board 81 is mounted on the frame 2, the optical adjustment is performed. With the optical adjustment, the position of the yoke board 62 is adjusted with respect to the guiding hole 21 and the guiding portion 22 in the frame 2.

As described above, in the optical pickup apparatus 1 of this embodiment, the compound chip 4, the first diffraction grating 42, and the second diffraction grating 43 are mounted in the element holder 40 mounted on the yoke board 62 which is layered on the top surface of the rigid wiring board 3. Therefore, as for the compound chip 4, the first diffraction grating 42, and the second diffraction grating 43, the optical axis can be adjusted based on the element holder 40. Also, the reflecting mirror 5 is mounted together with the element holder 40 on the surface of the yoke board 62 layered on the top surface of the wiring board 3; therefore, the optical axis of the reflecting mirror 5 can be adjusted based on the element holder 40. Thus, the optical axis of the reflecting mirror 5 can be easily adjusted with that of the compound chip 4, first diffraction grating 42, and second diffraction grating 43. Further, since the lens holder 61 is mounted on the yoke board 62 layered on the top surface of the wiring board 3, the optical axis of the objective lens 60 is adjusted based on the element holder 40. Consequently, the optical axis of the objective lens 60 can be easily adjusted with that of the compound chip 4, first diffraction grating 42, and second diffraction grating 43.

In this embodiment, as described, each element is mounted on the yoke board 62 layered on the top surface of the wiring board 3 to adjust the optical positional arrangement of each element on the yoke board 62; in addition, since the wiring board 3 on which each element is mounted is now mounted on the frame 2, the optical adjustment can be performed without requiring too much time and effort, compared to the related configuration in which each of the elements is directly mounted on the frame. Therefore, the productivity of the optical pickup apparatus 1 can be improved. Also, since the optical pickup apparatus 1 of this embodiment uses the wiring board 3, the electrical circuit and wiring patterns can be engraved into the wiring board 3 so that, without making the light source portion as a unit, the semiconductor laser and photo device in a chip condition can be wired with the wiring board 3 by means of wire bonding. Beside, since the wiring board 3 is used for electrical supply from the external source, only a single flexible print board 81 is sufficient, in contrast to the related configuration in which two of expensive flexible print boards are used. Therefore, it will not require too much time and effort to wire the flexible print board, and the cost of elements can be reduced.

Moreover, the flexible print board 81 connected to the lens holder 61 does not need to be wired to the external source, but merely needs to be connected to the wiring board 3; therefore, the time required for assembly can be shortened.

The heat generated by the compound chip 4 can be released efficiently through the yoke board 62 since the heat releasing board 62B is formed at the yoke board 62 and the compound chip 4 is arranged to be overlaid on the heat releasing board 62B. Since there is no need to mount an extra element for releasing heat, the productivity can be improved and the cost of elements can be reduced.

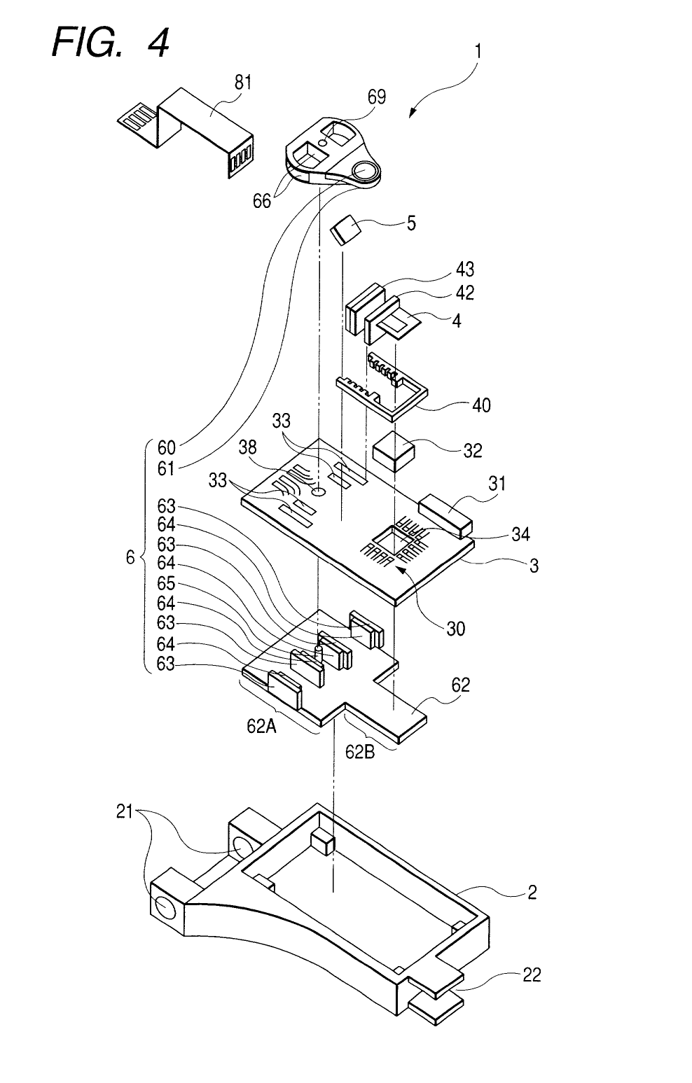

FIG. 4 is a perspective view of a dissembled optical pickup apparatus according to a second embodiment of the present invention. Note-that the optical pickup apparatus of this embodiment also uses the actuator that slides along and rotates around the shaft in the same manner as the first embodiment, and the principle thereof is as described referring to FIG. 1. Therefore, only the mounting structure of the feature element of this embodiment will be described.

Referring to FIG. 4, in the optical pickup apparatus 1 of this embodiment, the yoke board 62, on which the yoke portions 63 stand upright, and the rigid wiring board 3, such as a glass epoxy board or metallic board, are mounted inside the metallic frame 2 in this order. Thus, the yoke board 62 is layered under the bottom surface of the wiring board 3.

Also, in this embodiment, the pattern for electric supply to the semiconductor laser of the compound chip 4, the wiring pattern for signal output by the photo device, and the wiring pattern for electric supply to the drive coil are printed on the wiring board 3; the connector 31 is mounted on the wiring board 3 to wire the wiring patterns to the external source. Electronic elements such as resistance and condenser (not illustrated) are also mounted on the wiring board 3. Further, the reflecting mirror 5 is also mounted on the wiring board 3.

In the same manner as the first embodiment, in the wiring board 3, both the terminal formed at the end of the pattern for electric supply to the semiconductor laser of the compound chip 4 and the terminal formed at the end of the wiring pattern for signal output by the photo device are arranged in a predetermined area on the wiring board 3. The area in which these terminals are arranged is a chip mounting area 30 (light source mounting area).

The yoke board 62 is composed of a rectangular area 62A, in which the yoke portions are formed, and a rectangular heat releasing board-62B projecting from the rectangular area 62A to be of a T-shape; the yoke board 62 is layered under the bottom surface of the wiring board 3 such that the heat releasing board 62B is positioned underneath the chip mounting area 30.

In this embodiment, since the yoke board 62 is layered under the bottom surface of the wiring board 3 and the yoke portions 63 stand upright on the yoke board 62, slit-like openings 33 (first openings) are created to let the yoke portions 63 protrude upward. Also, since the shaft 65 stands upright on the yoke board 62, a circular opening 38 is created on the wiring board 3 to let the shaft 65 protrude upward.

In the wiring board 3, a rectangular opening 34 (second opening) is created in the area inside the chip mounting area 30. The bottom of the opening 34 is covered by the heat releasing board 62B of the yoke board 62, and a rectangular heat releasing piece 32 is fitted in the opening 34. Even under the condition where the heat releasing piece 32 is fitted in the opening 34 in this manner, since the top surface of the wiring board 3 is flat, the element holder 40 can be placed in the chip mounting area 30.

The element holder 40 is for positioning and holding the compound chip 4, the first diffraction grating 42, and the second diffraction grating 43; it is a substantially U-shaped (plan view) enclosure member composed of photosensitive glass. The element holder 40 has recesses, protrusions, and windows inside thereof for holding the compound chip 4, the first diffraction grating 42, and the second diffraction grating 43 in predetermined positional arrangements. Therefore, by merely mounting the compound chip 4, the first diffraction grating 42, and the second diffraction grating 43 in the element holder 40, the bottom surface of each element contacts the heat releasing piece 3 inside the opening 34, the bottom surface of the heat releasing piece 32 is supported by the heat releasing board 62B of the yoke board 62. Thus, the optical adjustment is automatically performed among the elements.

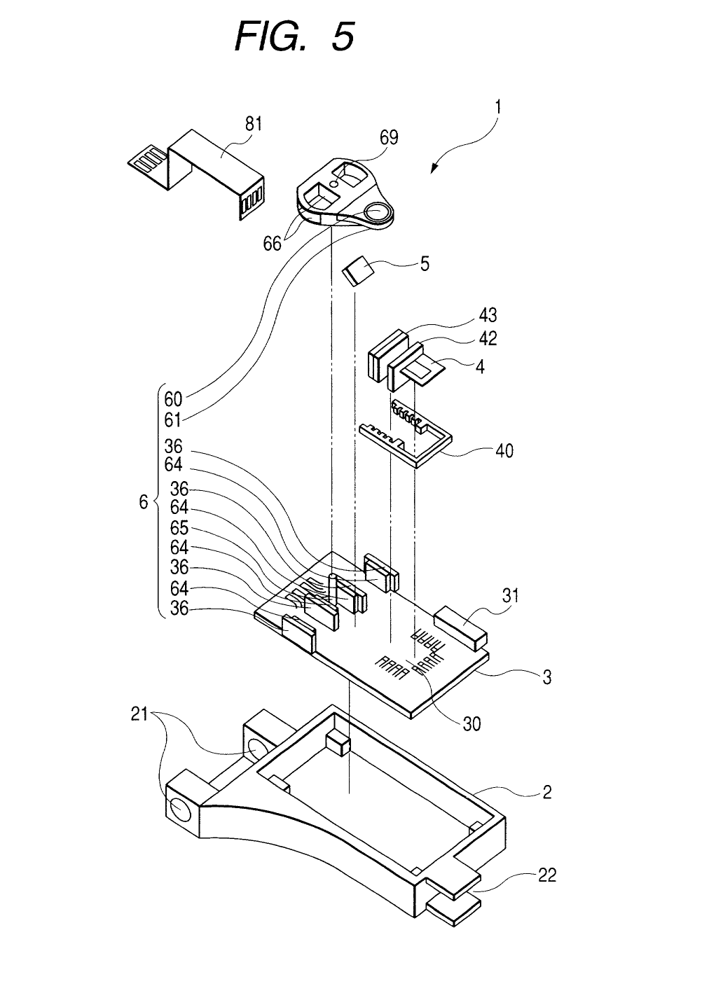

In this embodiment, also the lens holder 61 is supported with respect to the shaft 65, and the lens holder 61 and the wiring board 3 are electrically connected through the flexible print board 81; thus, other configurations remain the same as the first embodiment. Therefore, the common elements are given the same codes in FIG. 5, and the descriptions thereof are omitted.

Thus, in the optical pickup apparatus of this embodiment, the compound chip 4, the first diffraction grating 42, the second diffraction grating 43 are mounted in the element holder that is mounted on the wiring board 3. Therefore, the optical axis of the compound chip 4,-first diffraction grating 42, and second diffraction grating 43 can be adjusted based on the element holder 40. Since the reflecting mirror 5 is also mounted on the wiring board 3, the optical axis thereof can also be adjusted based on the element holder 40. Consequently, the optical axis of the reflecting mirror 5 can be easily adjusted to that of the compound chip 4, first diffraction grating 42, and second diffraction grating 43. Further, since the lens holder 61 is mounted onto the shaft 65 on the yoke board 62 that is layered on the wiring board 3, the optical axis of the objective lens 60 is also adjusted based on the element holder 40. Therefore, the optical axis of the objective lens 60 can be easily adjusted to that of the reflecting mirror 5, compound chip 4, first diffraction grating 42, and second diffraction grating 43.

As described, in this embodiment, by mounting each element on the wiring board 3 or the yoke board 62 layered on the wiring board 3, the optical positional arrangement of each element is adjusted on the wiring board 3 and the yoke board 62. Therefore, compared to the related configuration in which each element is directly mounted on the frame, the optical adjustment can be performed with less time and effort. Accordingly, the productivity of the optical pickup apparatus 1 can be improved. Since the optical pickup apparatus 1 of this embodiment also uses the wiring board 3, electrical circuits can be engraved into the wiring board 3; therefore, the semiconductor laser and photo device in a chip condition may be wired to the wiring board 3 by means of wire bonding. Because the wiring board 3 is used, a single flexible print board 81 is sufficient, whereas the related art uses two expensive flexible print boards. Consequently, there needs less time and effort for wiring the flexible print board, reducing the cost of elements.

Furthermore, the heat releasing board 62B is formed at the yoke board 62, and the compound chip 4 is positioned to be overlaid on the heat releasing board 62B via the heat releasing piece 32; therefore, the heat generated by the compound chip 4 can be released efficiently through the yoke board 62.

In this embodiment, since the yoke board 62 is layered under the back surface of the wiring board 3, the front surface of the wiring board 3 can provide a wide area for mounting elements.

FIG. 5 is a perspective view of a dissembled optical pickup apparatus of third embodiment of the present invention. Note that the optical pickup apparatus of this embodiment also uses the actuator that slides along and rotates around the shaft in the same manner as the first embodiment, and the principle thereof is as described referring to FIG. 1. Therefore, only the mounting structure of the feature element of this embodiment will be described.

Referring to FIG. 5, in the optical pickup apparatus 1 of this embodiment, the rigid wiring board 3 composed of an iron board is mounted inside the frame 2. On the wiring board 3, the pattern for electric supply to the semiconductor laser of the compound chip 4, the wiring pattern for signal output by the photo device, and the wiring pattern for electric supply to the drive coils are formed and the connector 31 is mounted for wiring the wiring patterns to the external source. In addition, electric elements such as resistance and condenser (not illustrated) are mounted on the wiring board 3. Further, the reflecting mirror 5 is also mounted on the wiring board 3.

In the same manner as the first embodiment, both the terminal formed at the end of the pattern for the electric supply to the semiconductor laser of the compound chip 4 and the terminal formed at the end of the wiring pattern for signal output by the photo device are arranged in a predetermined area on the wiring board 3. The area in which these terminals are arranged is a chip mounting area 30.

In this embodiment, the wiring board 3 is composed of an iron board and the base thereof is an iron used as a yoke material. The wiring board 3 is partially cut and stood up to form the yoke portions 36, and the shaft 65 is bonded upright on the wiring board 3.

In this embodiment, the element holder 40 is directly mounted on the wiring board 3. The element holder 40 is for positioning and holding the compound chip 4, the first diffraction grating 42, and the second diffraction grating 43; it is a substantially U-shaped (plan view) enclosure member composed of a photosensitive glass. The element holder 40 has recesses, protrusions, and windows inside thereof for holding the compound chip 4, the first diffraction grating 42, and the second diffraction grating 43 in predetermined positional arrangements. Therefore, by merely mounting the compound chip 4, the first diffraction grating 42, and the second diffraction grating 43 in the element holder 40, the bottom surface of each element contacts the top surface of the wiring board 3, and the optical adjustment is automatically performed among the elements.

In this embodiment, the lens holder 61 is also supported with respect to the shaft 65, and the lens holder 61 and the wiring board 3 are electrically connected through the flexible print board 81; thus, other configurations remain the same as the first embodiment. Therefore, the common elements are given the same codes in FIG. 5, and the descriptions thereof are omitted.

In the optical pickup apparatus of this embodiment, the compound chip 4, the first diffraction grating 42, the second diffraction grating 43 are mounted in the element holder that is mounted on the wiring board 3. Therefore, the optical axis of the compound chip 4, first diffraction grating 42, and second diffraction grating 43 can be adjusted based on the element holder 40. Since the reflecting mirror 5 is also mounted on the wiring board 3, the optical axis thereof can also be adjusted based on the element holder 40. Consequently, the optical axis of the reflecting mirror 5 can be easily adjusted to that of the compound chip 4, first diffraction grating 42, and second diffraction grating 43. Further, since the lens holder 61 is also mounted on the shaft 65 bonded on the wiring board 3, the optical axis of the objective lens 60 is also adjusted based on the element holder 40. Therefore, the optical axis of the objective lens 60 can be easily adjusted to that of the reflecting mirror 5, compound chip 4, first diffraction grating 42, and second diffraction grating 43. Thus, the time and effort required for the optical adjustment can be greatly reduced, improving the productivity of the optical pickup apparatus 1.

Since the optical pickup apparatus 1 of this embodiment also uses the wiring board 3, a single flexible print board 81 is sufficient while the related art uses two of expensive flexible print boards. Consequently, there needs less time and effort for wiring the flexible print board, reducing the cost of elements. Thus, the same effects as the first embodiment can be obtained.

Further, since the yoke portions 63 are formed by the wiring board 3 itself, the number of elements can be reduced. Therefore, the productivity of the optical pickup apparatus 1 can be improved and the element cost can be reduced.

Furthermore, since the compound chip 4 is mounted on the wiring board 3 composed of an iron board, the heat generated by the compound chip 4 can be released efficiently through the wiring board 3, and also there is no need to adopt a complicated structure to increase the efficiency of heat release.

Note that, although the compound chip 4 of the integrated semiconductor laser and photo device, in which the sub mount board having the semiconductor laser for monitoring and the board having the semiconductor laser (light source) are layered on the main board, is used as a light source in each of the above embodiments, the present invention can be applied in an optical pickup apparatus that uses the above devices and optical elements made as a unit.

In each of the above embodiments, permanent magnets as the drive magnets 64 are attached to the yoke portions 63 and the driving coils 66 are provided in the lens holder 61. However, the driving coils 66 may be attached to the yoke portions 63 and the drive magnets may be attached in the lens holder 61.

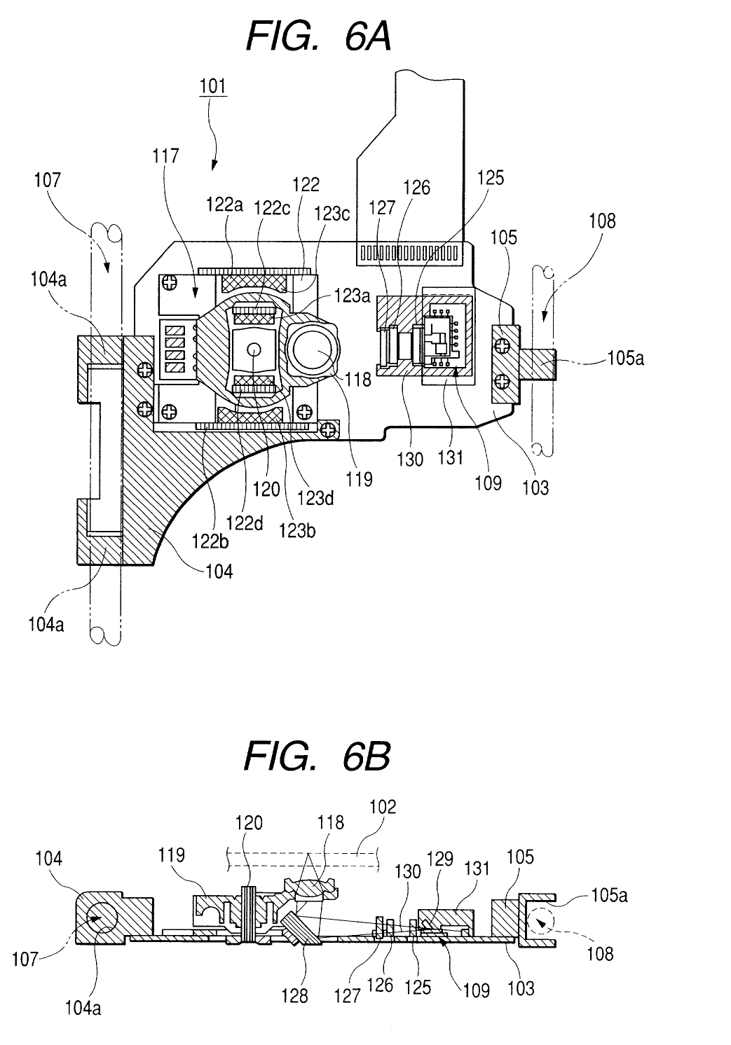

FIGS. 6A and 6B are, respectively, a plan view and a cross-sectional view of an optical pickup apparatus according to a fourth embodiment of the present invention; FIG. 7 is a plan view of a frame composed of a wiring board. Describing by referring to these drawings, the optical pickup apparatus 101 of this embodiment performs data recording/reproducing with respect to an optical recording medium 102 such as a CD or DVD; it has a frame 103 made of a metallic wiring board of, for example, aluminum, on which various elements are mounted. A primary shaft guide 104 made of resin, in which a circular primary guiding hole 104a is bored, is attached to one end of the wiring board frame 103; a secondary shaft guide 105 made of resin, in which a secondary shaft guiding groove 105a of a substantially U-shape, open to the side, is attached to the other end of the wiring board frame 103.

In an data recording/reproducing device (not illustrated) to which the optical pickup apparatus 101 is mounted, a primary shaft 107 and a secondary shaft 108 are arranged parallel to each other. The optical pickup apparatus 101 is mounted in the data recording/reproducing device with the condition that the wiring board frame 102 is bridged between the primary shaft 107 and the secondary shaft 108 so that the primary shaft 107 can be inserted through the primary shaft guiding hole 104a and the secondary shaft 108 can be inserted through the secondary shaft guiding groove 105a. Along the primary and secondary shafts, the optical pickup apparatus can move in the radial direction of the optical recording medium 102.

As seen in FIG. 7, the wiring board frame 103 has a wiring pattern 103a engraved on a surface of a rectangular aluminum substrate; screw holes 103b and 103c for fixing the primary shaft guide 104 and the secondary shaft guide 105, and an opening 103e and screw holes 103d for fixing a bent yoke board, which is a constituent of an objective lens driving mechanism (described later), are formed thereon.

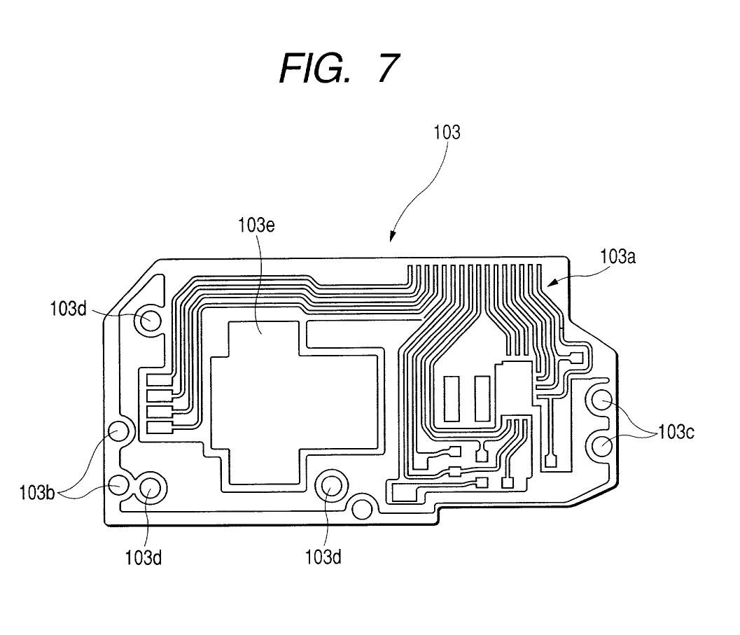

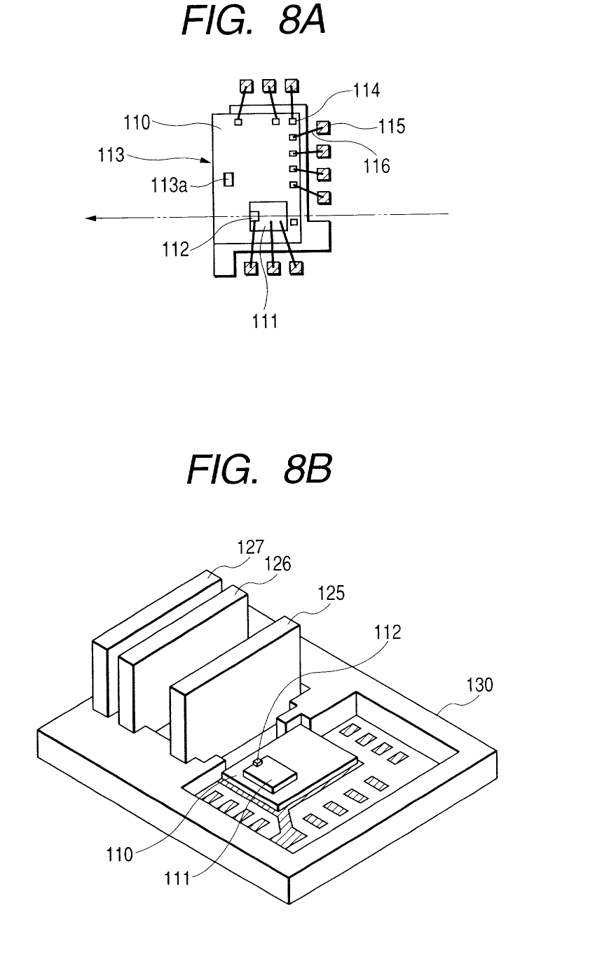

Mounted on the surface of the wiring board frame 102 on the secondary shaft guide 105 side is a compound chip 109 of an integrated semiconductor laser and photo device as shown in FIG. 8. The compound chip 109 has a semiconductor substrate 110, which is layered on the surface of the wiring board frame 103 with an adhesive such as an Ag paste, a sub mount 111, which is bonded on top of the semiconductor substrate 110, and a semiconductor laser chip (light source) 112 which is bonded on top of the sub mount 111.

Built in the semiconductor substrate 110 are a photo device 113 having a photo plane 113a for signal reproduction and an integrated circuit including a signal arithmetic circuit (not illustrated). Built in the sub mount 111 is a photo device for monitoring the semiconductor laser (not illustrated). As seen in FIG. 8, electrode terminals 114 formed on the compound chip 109 and electrode terminals 115 formed on the surface of the wiring board -frame 102 are electrically connected through bonding wires 116.

Mounted on the surface of the wiring board frame 103 on the primary shaft guide side is a magnetically driven objective lens driving mechanism 117. The objective lens driving mechanism 117 has a lens holder 119 holding an objective lens 118, a shaft 120 for supporting the lens holder 119 to move in the tracking direction and the focusing direction, and a magnetic driving circuit that generates the magnetic force to move the lens holder 119 in the tracking direction and the focusing direction. The magnetic driving circuit includes magnets 123a, 123b, 123c, and 123d attached to standing portions 122a, 122b, 122c, and 122d formed on a bent yoke board 122 and drive coils (not illustrated) positioned at the lens holding portion that faces the magnets. The shaft-sliding and shaft-rotating objective lens driving mechanism of this configuration is publicly known.

On an optical path from a semiconductor laser chip 112 to the objective lens 1-18, a first diffraction grating 125, a second diffraction grating 126, a third diffraction grating 127, and a mirror 128 that changes the optical path are arranged. The first diffraction grating 125 splits a laser light emitted by the semiconductor laser chip 112 into three beams; the second and third diffraction gratings 126 and 127 change the optical path of the returning light from the optical recording medium 102 and guide the light to the photo plane 113a on the photo device 113 via a total internal reflecting mirror 129. The mirror 128 reflects the emitted laser light at a right angle and guides it to the objective lens 118.

In this embodiment, the compound chip 109, and the diffraction gratings 125 through 127 are positioned and held in an element holder 130 and then mounted on the wiring board frame 103. As shown in FIG. 8B, the element holder 130 is an enclosure made of photosensitive glass, by notching a flat board in a substantially U-shape; it has recesses, protrusions, and windows inside thereof for holding the compound chip 109 and the diffraction gratings 125 through 127 in predetermined positions and arrangements. Therefore, as for the compound chip 109 and the diffraction gratings 125 through 127, by merely mounting them in the element holder 130, the adjustment of the optical axis and the positional adjustment of the direction of the optical path can be automatically performed among these elements.

A cover 131 is attached over the element holder 130 in which the compound chip 109 is mounted so that the compound chip 119 is sealed and protected. The total internal reflecting mirror 129 is attached to the back surface of the cover 131.

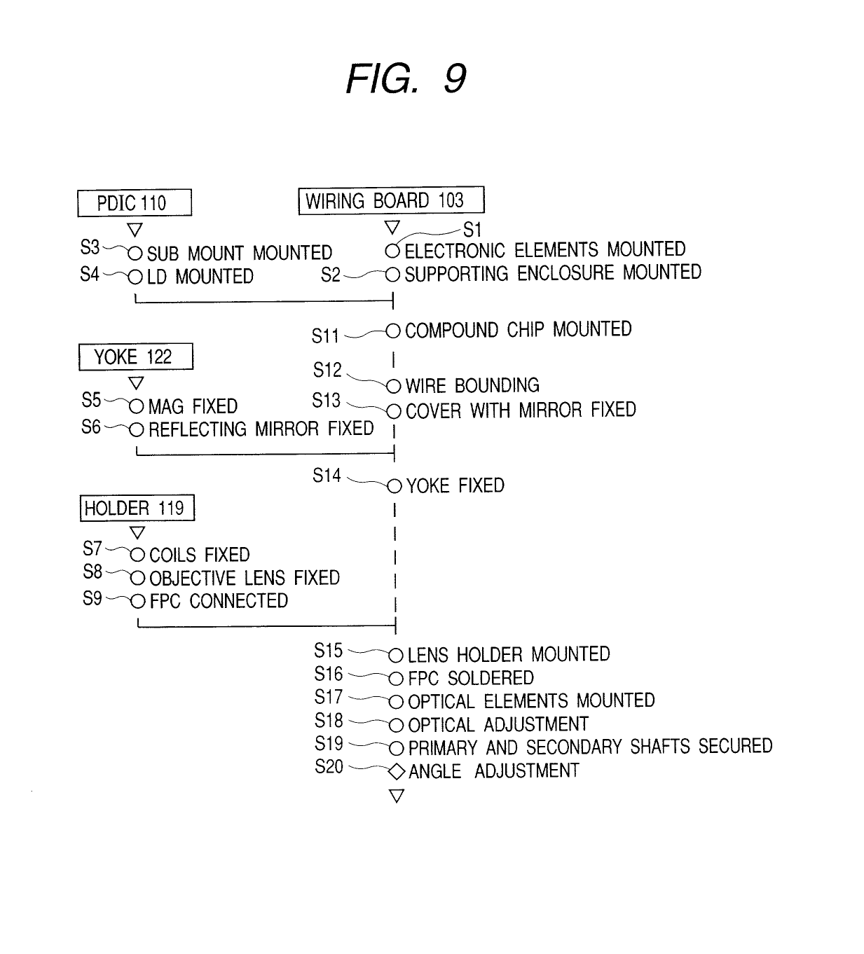

FIG. 9 shows an assembling process of the optical pickup apparatus 101 of the above configuration. According to this drawing, steps of mounting these elements on the wiring board frame 103 will be described.

First, a prepared wiring board frame 103 of a shape shown in FIG. 7 is prepared, necessary electronic elements are mounted (Step S1) and the element holder 130 is mounted (Step S2) thereon. Meanwhile, on a prepared semiconductor substrate (PDIC) 110 in which the photo device for signal reproduction 113 and the integrated circuit including the signal arithmetic circuit are built, the sub mount 111 and the semiconductor laser chip 112 are layered and bonded to create the compound chip 109 (Steps S3 and S4). Further, the magnets 123a through 123d are fixed on the standing portions 122a through 122d on the bent yoke 122, and the mirror 128 that changes the optical path (optical axis) is attached on the yoke 122 (Steps S5 and S6). On the lens holder 119, the drive coils (not illustrated) are first mounted, the objective lens 118 is then fixed, and finally a flexible print board (not illustrated) is connected (Steps S7, S8, and S9).

Next, the compound chip 109 is positioned on the positioning plane of the element holder 130 mounted on the wiring board frame 103, and fixed with an adhesive (Step S11). Then, the electrode portions on the compound chip 109 and the electrode terminals formed on the wiring board frame 103 are electrically connected by bonding wires (Step S12). Next, the cover 131 on which the total internal reflecting mirror 129 is attached is covered on the element holder 130 mounted on the wiring board frame 103, and fixed with an adhesive. (Step S13).

After this, the objective lens driving mechanism 117 is mounted on the wiring board frame 103. First, the bent yoke 122 is fixed on the wiring board frame 103 (Step S14), and the shaft 120 and the lens holder 119 are mounted on the yoke 122 (Step S15). Then, the flexible print board (FPC) is soldered to the terminal for electric supply to the drive coils, etc (Step S16).

Then, the first, second, and third diffraction gratings 125, 126, and 127 are mounted in the element holder 130 fixed on the wiring board frame 103, followed by adjusting the optical positions of these optical elements with respect to the semiconductor laser chip 112 and the photo device 113 (Step S17 and S18).

Finally, the primary shaft guide 104 and the secondary shaft guide 105 are respectively fixed at both ends of the wiring board frame 103, and the angle of the objective lens 118 is adjusted (Steps S19 and S20).

As described above, in the optical pickup apparatus 101 of this embodiment, the wiring board frame composed of a metallic wiring board is used as a device frame; the compound chip 109 is mounted on the surface of the frame, and the compound chip 109 and the wiring board frame are electrically connected through the wiring pattern 103a on the surface of the wiring board frame. Therefore, compared to a related art in which the semiconductor laser and the photo device are mounted on the surface of the device frame and another wiring board is used for electric supply to the elements, the configuration can be simplified and the device is minimized. Most importantly, the device can be made thin.

In other words, in the optical pickup apparatus 101 of this embodiment, since the wiring board frame 103 is used, the electrical circuits and wiring patterns can be engraved directly into the wiring board frame 103; therefore, without making the light source portion as a separate unit, the semiconductor laser and the photo device in a chip condition can be wired to the wiring board frame 103 by means of a wire bonding. Consequently, the device can be made thin without using an expensive light source unit. Also, since the wiring patterns engraved into the wiring board frame 103 can be used as the circuits for electric supply from the external source, there is no need to use an expensive flexible print board for electric supply. Further, not as time and effort is required for electrically connecting the flexible print board, thus reducing the cost of elements.

Also, since the compound chip 109, the source of heat generation, is directly mounted on the surface of the wring board frame 109 composed of a metallic wiring board, a heat releasing means, such as a heat releasing board, does not need to be configured separately, but a desirable capability of heat release can still be obtained. With this configurations the device can be made small, especially thin.

Furthermore, the compound chip 109 and the diffraction gratings 125 through 127 are mounted in the element holder 130 bonded on top of the wiring board frame 103; therefore, the optical axis of the optical elements can be adjusted based on the element holder 130.

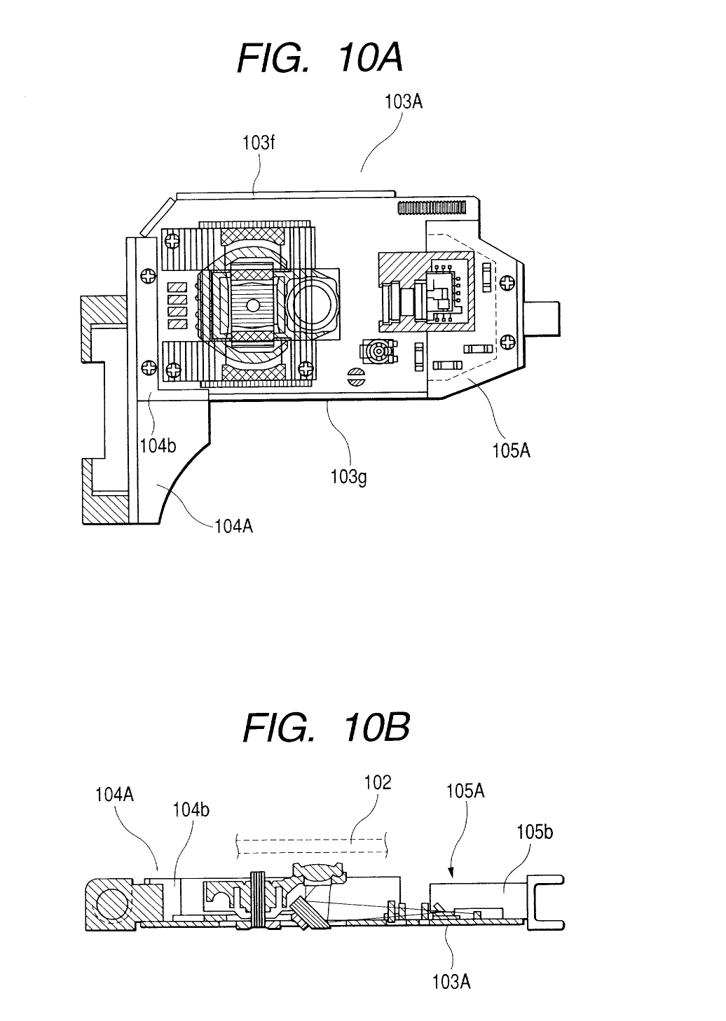

FIG. 10 shows an example of modification of the wiring board frame 103. A wiring board frame 103A shown in this figure has reinforced portions 103f and 103g which are formed by standing both edges of the frame between the primary shaft guide 104A and the secondary shaft guide 105A at a right angle. With such reinforced portions 103f and 103g, the out-of-plane rigidity of the wiring board frame 103A can be increased, thus increasing resonance frequency.

Note that in the example shown in the figure, a thick reinforced portion 104b is formed at the primary shaft guide 104A along the outer periphery of the wiring board frame 103A. Also, a thick reinforced portion 105b is formed at the secondary shaft guide 105A along the outer periphery of the wiring board frame 103A.

Therefore, by using the wiring board frame 103A, the primary shaft guide 104A, and the secondary shaft guide 105A of this example, the mechanical rigidity of the optical pickup apparatus 101 can be increased. Note that since other configurations remain the same as the aforementioned optical pickup apparatus 101, the description thereof is omitted:

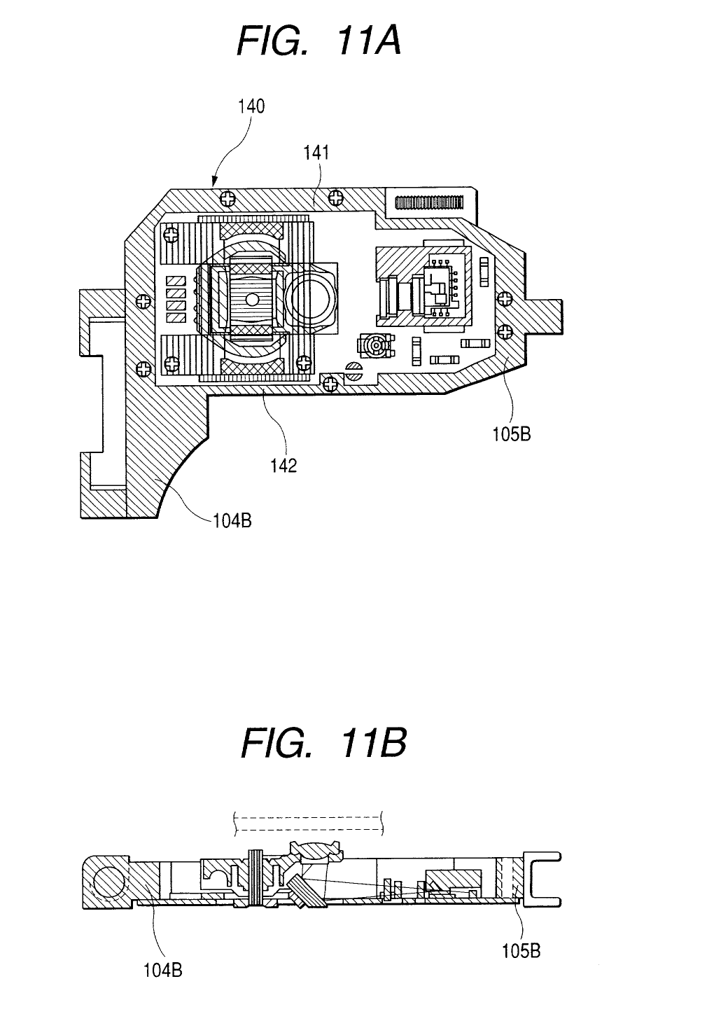

FIG. 11 shows an example of modification of the primary shaft guide 104 and secondary shaft guide 105. Used in this example is an enclosure 140 in which the primary shaft guide 104B and the secondary shaft guide 105B are connected to each other. In the enclosure 140, connecting portions 141 and 142 for connecting both guiding portions are formed along the outer periphery of the wiring board frame 103 and fixed to the outer periphery.

Using the enclosure 140 configured as above can increase the out-of-plane rigidity of the wiring board frame 103.

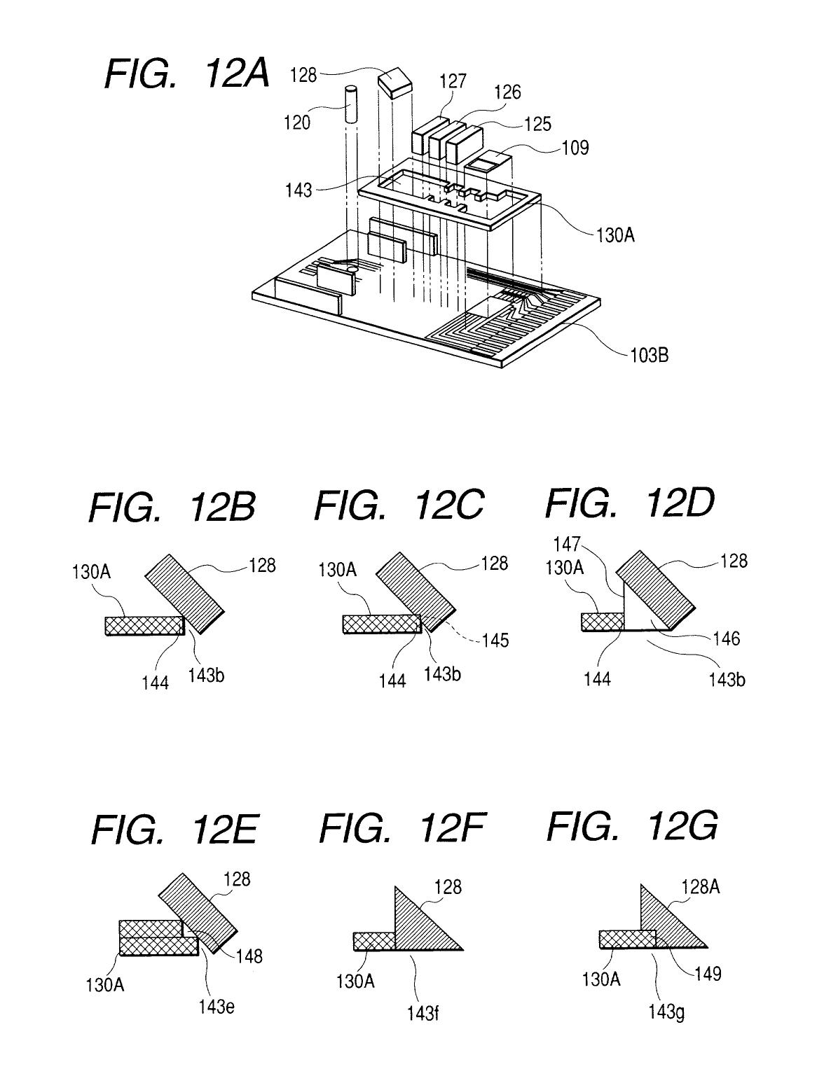

FIG. 12A shows an example of modification of the wiring board frame 103 and element holder 130. The bent yoke board 122, which is a constituent of the objective lens driving mechanism 117, is used as a wiring board frame 103B shown in this figure. In other words, a portion of the wiring board frame 103B is bent to form a magnet mounting portion. With this configuration, the number of elements to be used can be reduced, and the assembly process can be simplified.

In this embodiment, the element holder 130A is extended to the position of the mirror 128 that changes the optical path; a mirror mounting portion 143 is formed in the extended portion to mount the mirror 128 that changes the optical path. With this configuration, the position of the mirror 128 is also determined by the element holder 130A; thus, the positioning of the mirror is simplified.

The structure of the mounting portion 143 of the mirror 128 can be of any in FIGS. 12B through 12G. The mounting portion 143b shown in FIG. 12B is an opening bored in the element holder 130A, -and a flat mirror 128 that changes the optical path is bonded to the edge 144 thereof at an angle of 45 degrees.

The mounting portion 143c shown in FIG. 12C is formed such that the opening edge 144 formed in the element holder 130A is given a half etching to create an inclined surface 145 at an angle of 45 degrees, on which the flat mirror 128 contacts. The mounting portion 143d shown in FIG. 12D has the same edge 144 as that of the mounting portion 143b, but a triangle holding portion 146 is formed integrally on the back surface of the flat mirror 128 and a perpendicular plane 147 of the holding portion is bonded to the mounting portion 143d.

The mounting portion 143e shown in FIG. 12E is formed such that the opening edge 148 is given a half etching or another board is adhered on the mounting portion 143e so that the flat mirror 128 can be mounted at an angle of 45 degree. The mounting portion 143f shown in FIG. 12F is the same edge 144 as that of the mounting portion 143b, but a triangle prism 128A is used as the mirror 128 to change the optical path. The mounting portion 143g of FIG. 12G is formed such that the triangle prism 128A as the mirror is given a step-like notch and put together with the end portion 149 of the mounting portion.

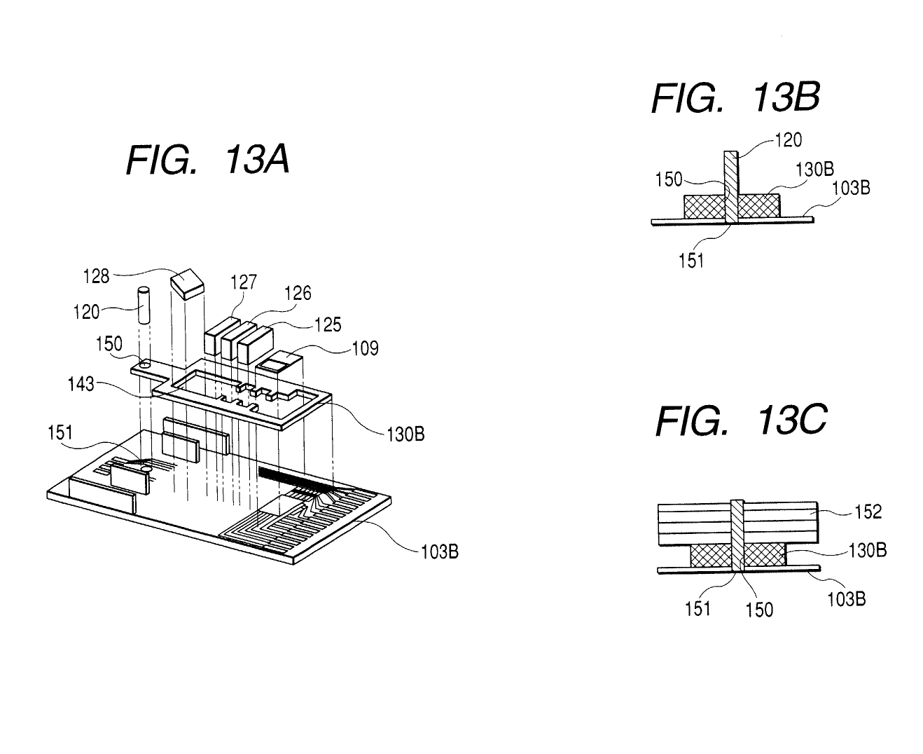

Next, FIG. 13 shows an example of modification of the element holder 130A shown in FIG. 12A. An element holder 130B shown in this figure has an extended portion beyond the mirror mounting portion 143, in which a shaft hole 150 for the shaft 120 is formed.

As a method of fixing the shaft 120, FIG. 13B shows that the shaft 120 is caulked in the fixing hole 150 and the fixing hole 151 bored in the wiring board frame 103B and bonded therein with an adhesive. To stabilize the shaft in the height direction, the shaft 120 may be fixed in the frame through a positioning dummy board 152, as shown in FIG. 13C.

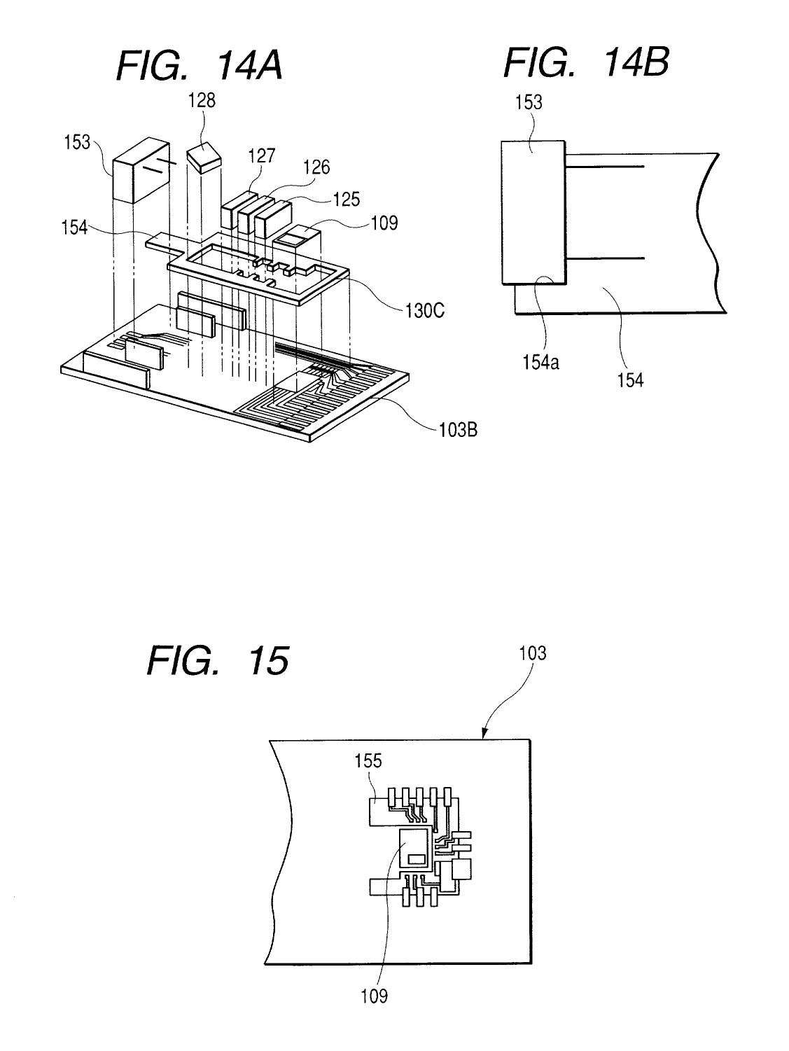

Next, known as the objective lens driving mechanism beside the above mentioned shaft-sliding and rotating type is a mechanism that supports the objective lens holder holding the objective lens to move in the tracking and focusing directions by means of a wire suspension. With this, a positioning portion 154 may be formed at an element holder 130C for mounting a wire suspension retaining board 153, as shown in FIG. 14A. The positioning portion 154 is formed with an end surface 154a for positioning the wire suspension retaining board 153, as shown in FIG. 14B.

As for the configuration of mounting the compound chip 109 onto the wiring board frame 103, as illustrated in FIG. 15, an Au-plated resin substrate 155 may be mounted on the surface of the wiring board frame 103, the electrodes be soldered between the substrate and board frame, and the compound chip 109 be mounted on the Au-plated rein substrate 155. With this configuration, there is no need to coat the surface of the wiring board frame 103 with Au-plating, thus reducing the cost.

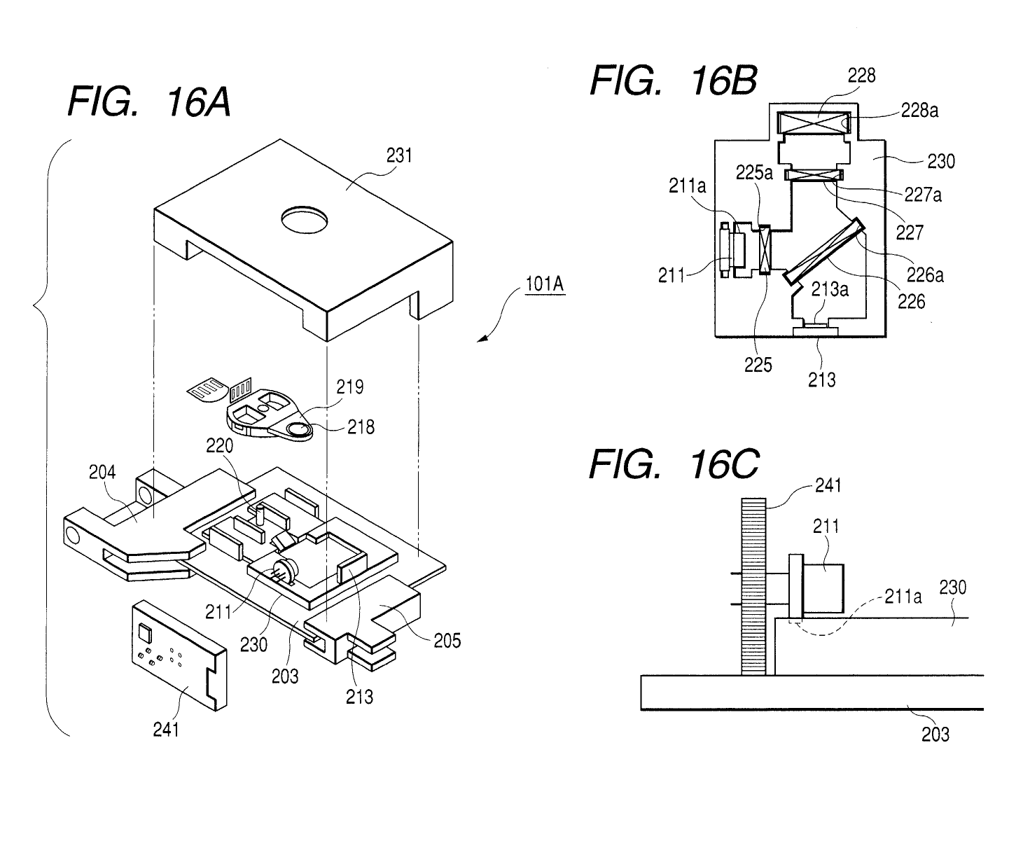

FIG. 16 shows a perspective view of an optical pickup apparatus according to a fifth embodiment of the present invention, a mounting diagram of optical elements, and a detailed mounting diagram of a semiconductor laser. An optical pickup apparatus 201A of this embodiment is of a so-called bulk type in which a semiconductor laser and a photo device provided as individual elements are used, instead of mounting a semiconductor substrate in which a photo device for signal reproduction is built in.

As shown in the figures, even in the optical pickup apparatus 201A of this embodiment, the device frame is a wiring board frame 203 made-of a metallic wiring board, and primary shaft guide 204 and secondary shaft guide 205 are attached to both sides thereof. On the wiring board frame 203, an element holder 230 made of photosensitive glass is -mounted, on which portions 211a and 213a for mounting a semiconductor laser 211 and a photo diode 213 are formed. Also, formed in the element holder are portions 225a, 226a, 227a, 218a, and 228a for mounting a grating 225, a half mirror 226, a collimate lens 227, and a mirror 228 that changes the optical path; the grating 225 is for splitting a laser light emitted by the semiconductor laser 211 into three beams, the half mirror 226 is for separating the emitted laser light from the returning light, the collimate lens 227 is for collimating the emitted laser light, and the mirror 228 is for standing the emitted laser light at a right angle and guides it to the objective lens 218.

Also on the wiring board frame 203, a bent yoke 212 is mounted, a shaft 220 stands upright in the center of yoke, and the lens holder 219 holding the objective lens 218 is supported on the shaft.

Note that as shown in FIG. 16C, the semiconductor laser 211 is soldered such that three lead pins thereof are positioned at a right angle with respect to the side surface of the print board 241 for electric supply, which is soldered perpendicularly on the wiring board frame 203. Each element mounted on the wiring board frame 203 is covered by a cover 231.

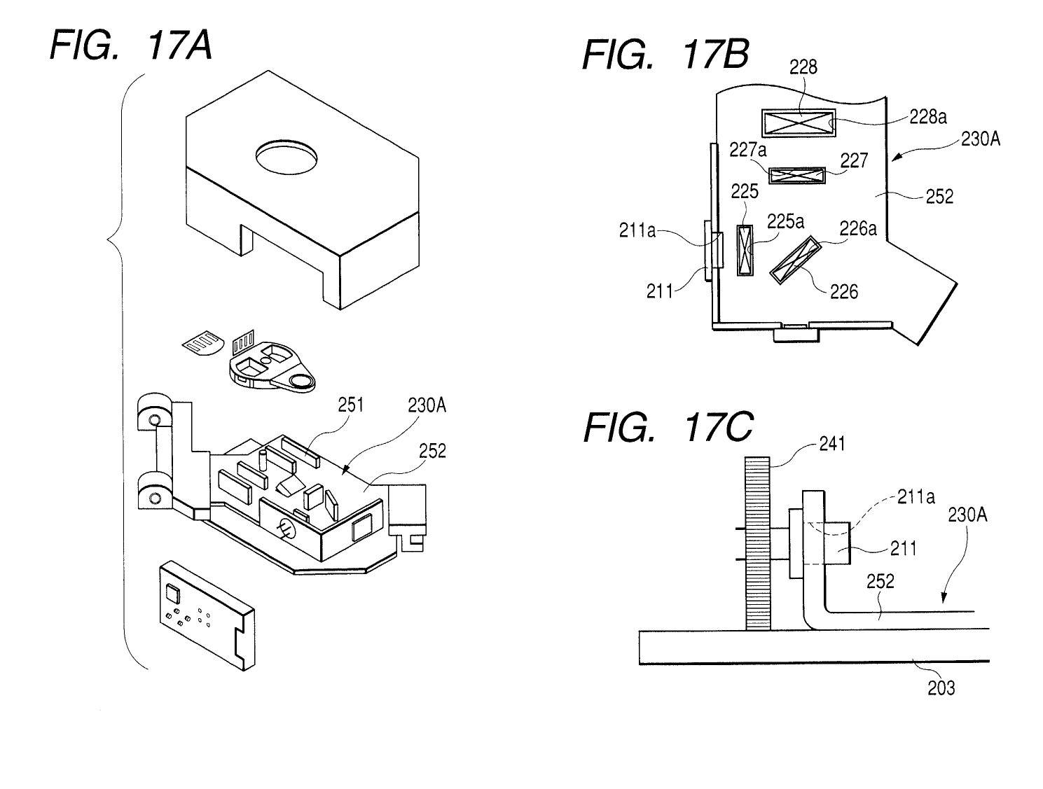

FIG. 17A shows an example of modification of the element holder 230. An element holder 230A shown in this figure is formed by extending the bent yoke 222. In other words, the bent yoke 222 and the element holder 230 are formed of a single element. Therefore, the element holder 230A has a yoke portion 251 that functions as the bent yoke 222 and an element holding portion 252 that functions as the element holder 230. FIG. 17B shows the element holding portion 252; formed thereon are a mounting portion 211 a for the semiconductor laser 211, a mounting portion 213a for the photodiode 213, a mounting portion 225a for the grating 225, a mounting portion 226a for the half mirror 226, a mounting portion 227a for the collimate lens 227, and a mounting portion 228a for the mirror 228. The mounting portion 211a for the semiconductor laser is an opening bored in a bent yoke portion 253 that stands perpendicularly shown in FIG. 17C.

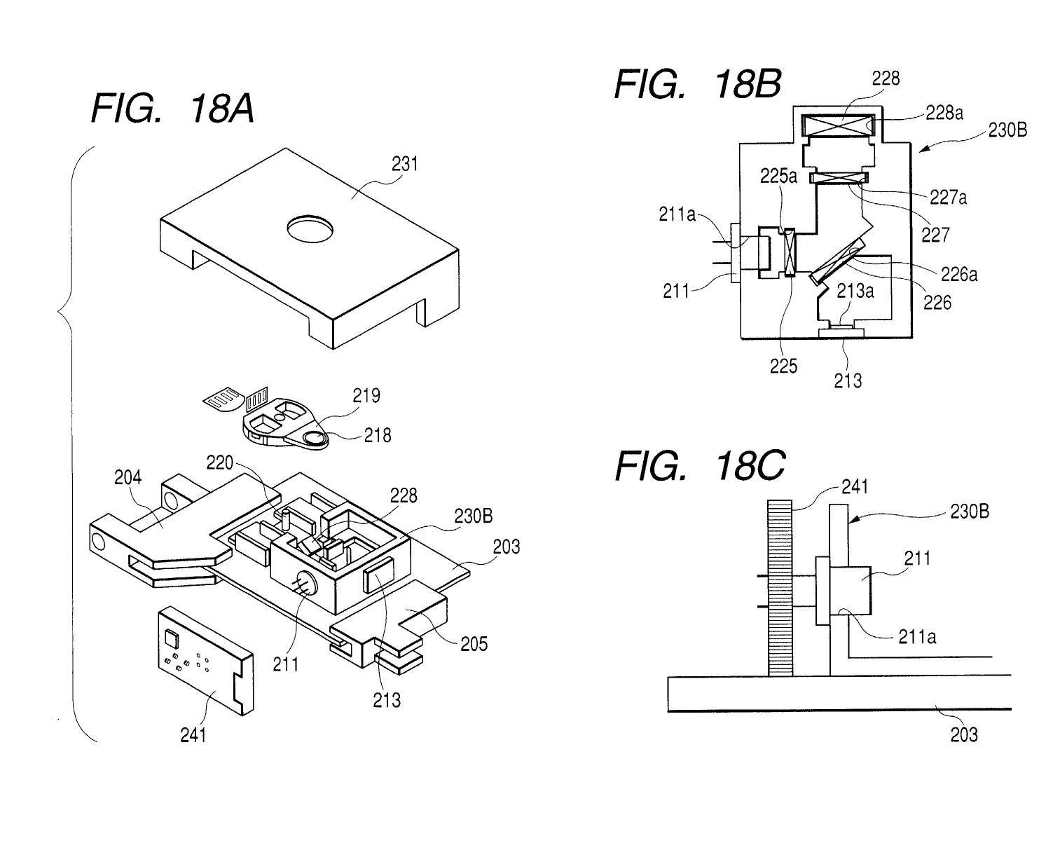

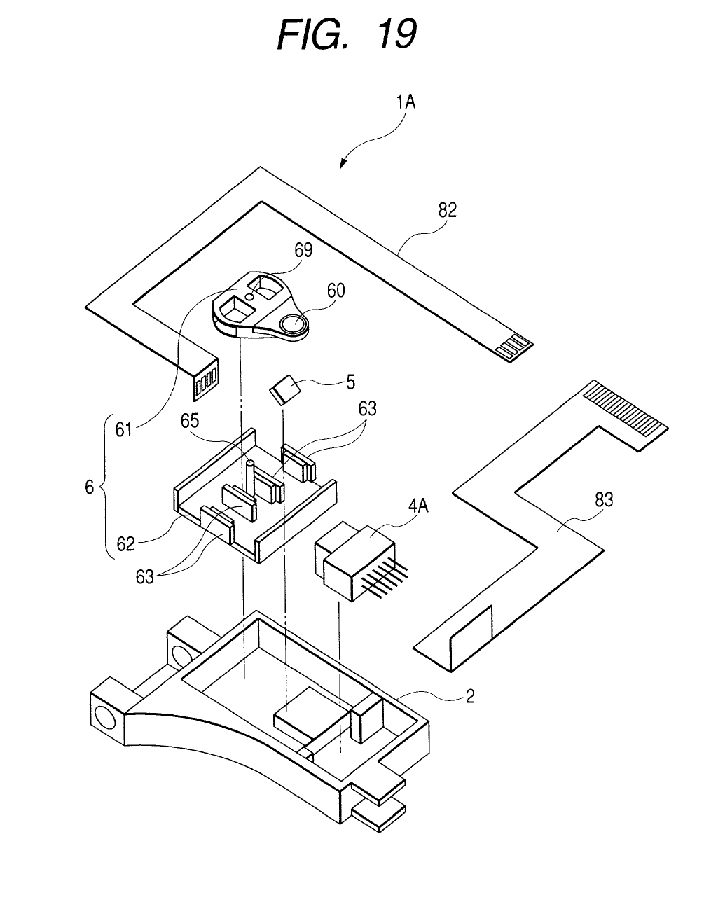

Next, FIGS. 18A to 18C show a resin element holder 230B. When the element holder 230B is used, other elements remain the same as those in the optical pickup apparatus 101A shown in FIGS. 16A to 16C; therefore, the detailed description thereof is omitted, and the same codes are given to the corresponding elements in the figures.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. An optical pickup apparatus comprising:
a light source;
a lens holder holding an objective lens and driven at least in the focusing or tracking direction, said objective lens condensing a light emitted by said light source onto an optical recording medium;
a photo device that receives a returning light from said optical recording medium;
a plurality of optical elements that guide said light emitted by said light source to said objective lens and also guide said returning light to said photo device; and
a frame onto which said light source, said lens holder, said photo device, and said optical elements are mounted,
wherein said light source, said lens holder, said photo device, said optical elements are mounted on a rigid wiring board, on which wiring patterns for electric supplies to said light source and photo device are formed, and then mounted onto said frame.

2. The optical pickup apparatus as set forth in claim 1, wherein said light source, said photo device, and at least some of said optical elements are positioned in an element holder and then mounted on said wiring board.

3. The optical pickup apparatus as set forth in claim 1, wherein said lens holder and said wiring board are electrically connected through a flexible print board used for electric supply to drive coils formed in said lens holder.

4. The optical pickup apparatus as set forth in claim 1, wherein a yoke board is arranged to be layered on a top surface of said wiring board, said yoke board having uprightly standing yoke portions to which drive magnets or drive coils are attached for driving said objective lens; and said light source is arranged in a predetermined position on said yoke board.

5. The optical pickup apparatus as set forth in claim 1, wherein a yoke board is arranged to be layered under the bottom surface of said wiring board, said yoke board having uprightly standing yoke portions to which drive magnets or drive coils are attached for driving said objective lens; and
wherein said wiring board has first openings to let said yoke portions stick out therefrom and a second opening to position a heat releasing piece in the area said light source is positioned and adjacent to said yoke board.

6. The optical pickup apparatus as set forth in claim 4, wherein said yoke portions are formed by bending portions of said yoke board.

7. The optical pickup apparatus as set forth in claim 1, wherein said wiring board has a board composed of a yoke material, and by bending portions of said wiring board, yoke portions are formed for attaching drive magnets or drive coils that drive said objective lens.

8. An optical pickup apparatus comprising:
a light source, a photo device and optical elements, constructing an optical system for converging a light emitted by said light source on an optical recording medium and guiding a returning light reflected by said optical recording medium to said photo device;
a frame on which said light source, said photo device and said optical elements are mounted, the frame having a primary shaft guide and a secondary shaft guide attached thereto,
wherein said frame is composed of a wiring board having wiring patterns, including circuits of electric supply to said light source and said photo device.

9. The optical pickup apparatus as set forth in claim 8, wherein said wiring board is a metallic board.

10. The optical pickup apparatus as set forth in claim 8, wherein said wiring board has reinforced portions formed by bending portions thereof in the out-of-plane direction.

11. The optical pickup apparatus as set forth in claim 8, wherein portions of said primary shaft guide and secondary shaft guide are connected to each other.

12. The optical pickup apparatus as set forth in claim 8, further comprising an element holder mounted on said wiring board, which has portions for positioning some of said optical elements, said light source, and said photo device.

13. The optical pickup apparatus as set forth in claim 12, further comprising:
a lens holder holding an objective lens which is a constituent of said optical system; and
a lens holder shaft for supporting said lens holder to move in the tracking and focusing directions,
wherein said element holder has a fixing hole for said lens holder shaft.

14. The optical pickup apparatus as set forth in claim 13, wherein a magnetic driving mechanism is mounted on said wiring board for moving said lens holder in the tracking and focusing directions, and a yoke board, to which magnets, constituents of said magnetic driving mechanism, are attached, is formed as a part of said element holder.

15. The optical pickup apparatus as set forth in claim 12, further comprising:
a lens holder holding an objective lens which is a constituent of said optical system; and
a wire suspension retaining board for supporting said lens holder to move in the tracking and focusing directions by means of a wire suspension method,
wherein said element holder has a portion for mounting said wire suspension retaining board.

16. The optical pickup apparatus as set forth in claim 12, wherein said element holder is made of photosensitive crystallized glass.
